(19) United States
(12) Patent Application Publication
(10) Pub. No.: US 2022/0119609 A1
(43) Pub. Date: Apr. 21, 2022

(54) WATER-SOLUBLE PLASTIC ARTICLE

(71) Applicant: FOSTAG Formenbau AG, Stein am Rhein (CH)

(72) Inventor: Rolf MÜHLEMANN, Schlattingen (CH)

(73) Assignee: FOSTAG Formenbau AG, Stein am Rhein (CH)

(21) Appl. No.: 17/428,076

(22) PCT Filed: Feb. 6, 2020
(86) PCT No.: PCT/EP2020/053016

§ 371 Date: Aug. 3, 2021

(30) Foreign Application Priority Data
Feb. 6, 2019 (CH) 00138/19
Apr. 12, 2019 (CH) 00500/19
Sep. 3, 2019 (CH) 01108/19
Nov. 4, 2019 (CH) 01386/19

(51) Int. Cl. C08J 7/04; B29C 45/00; B65D 65/46

(52) U.S. Cl. CPC C08J 7/0427; B29K 2029/04; B65D 65/466; B29C 45/0001

(57) ABSTRACT

A plastic product has a plastic body injection-moulded or deep-drawn from water-soluble polyvinyl alcohol (PVOH). The surface of the plastic body, which is exposed to ambient moisture or a water-containing substance from completion of the plastic product up to and during the intended use of the plastic product is completely coated with a continuous, water-impermeable and water-resistant protective layer and the plastic body can be completely dissolved in water after the intended use of the plastic product when a non-coated surface is exposed or after the continuous protective layer is destroyed. The protective layer is applied so thinly that it disintegrates or can be separated out of the water after the dissolution of the plastic body, and/or the protective layer (3) has a melting temperature between 50° C. and 90° C., preferably 60° C. to 85° C.

### TECHNICAL FIELD

The invention relates to a plastic product having a plastic body injection-moulded or deep-drawn from water-soluble polyvinyl alcohol (PVOH).

### TECHNICAL BACKGROUND

There is an increasing need for environmentally friendly plastic products. Consumable articles in particular, e.g. disposable articles such as plastic plates, cups or cutlery, but also plastic packaging containers such as food, luxury food or drug packaging, should increasingly be environmentally soundly disposable or even compostable.

In order to manufacture compostable plastic products for example, compostable or biodegradable plastics, such as polymers based on starch (starch blends), polylactic acid (PLA), polyester of the type polyhydroxyalcanoate (PHA), polyhydroxybutyrate (PHB), polyhydroxyvalerate (PHV), or cellulose materials made from chemically modified cellulose are chosen for production. These materials are broken down partially or completely after their use phase by microorganisms such as fungi and bacteria into water and carbon dioxide, but are sufficiently resistant that they survive the necessary storage times up to the end consumer.

In addition to compostability, plastic packaging containers should today have a barrier layer with respect to oxygen, in order to increase the shelf life of the filling material. To this end, the plastic packaging containers are provided with a barrier layer, which strongly reduces the gas permeability of plastics that are used conventionally.

Methods and devices for producing packaging parts (injection-moulded parts inter alia) with a barrier layer with a good passage-blocking effect with respect to water vapour and gases are for example known from WO2009030425 and EP1048746. Here, the packaging parts are formed by thermoforming of flat film material, by injection moulding or by a combination of injection moulding and blow moulding (injection blow moulding) or extrusion and blow moulding (extrusion blow moulding) and are made from polyethylene (PE), polypropylene (PP), cyclic olefin copolymer (COC), cyclic olefin polymer (COP), polyvinyl chloride (PVC), polyethylene terephthalate (PET) or polyamide, wherein compostable polymers, such as starch-based polymers (starch blends), polylactic acid (PLA), polyester of the type polyhydroxyalcanoate (PHA), polyhydroxybutyrate (PHB), polyhydroxyvalerate (PHV), or cellulose materials made from chemically modified cellulose are also mentioned. Subsequently, the packaging parts are provided with a ceramic and/or metallic vacuum coating by means of plasma CVD methods or by means of sputtering methods.

A compostable plastic packaging container made from compostable polylactic acid (PLA) with a compostable barrier layer made from polyvinyl alcohol (PVOH) is described in WO2015082982. The plastic packaging container is produced in terms of injection moulding technology by means of a coinjection method, in which a PVOH barrier layer with a thickness of a few micrometres is injected into a mould between two outer PLA layers. Although such plastic packaging containers are compostable or biodegradable, the complete decomposition thereof by microorganisms such as fungi and bacteria is for the most part only possible by means of industrial composting under defined conditions. Composting e.g. in domestic compost would take many months to years, however.

WO9846668 describes a synthetic resin coating for biodegradable articles. The coating has irregularities or faults, so that water can penetrate as far as the non-water-resistant layer of the article, which is located therebelow. Alternatively, a hydratable coating is described, which swells and tears upon contact with water, so that the non-water-resistant layer of the article, which is located therebelow, is exposed. However, the coating is not suitable for injection-moulded articles which must have a long storage life of several months to several years or which come into contact with aqueous liquids during storage.

### DESCRIPTION OF THE INVENTION

It is an object of the invention to specify a plastic product which can be stored over several months to years and can be environmentally soundly disposed of in a simple manner after an intended use.

This object is achieved by a plastic product with the features of the independent claims. The plastic product has a plastic body injection-moulded or deep-drawn from water-soluble polyvinyl alcohol (PVOH). The surface of the plastic body, which is exposed to ambient moisture or a water-containing substance from completion of the plastic product until and during the intended use of the plastic product, is coated completely with a continuous water-impermeable and water-resistant protective layer. Furthermore, after the intended use of the plastic product, the plastic body is, upon exposure of a non-coated surface or after active destruction of the continuous protective layer, completely soluble in water, preferably between 10 and 60 degrees Celsius.

The protective layer can be applied thinly, such that it disintegrates or can be separated from the water after the dissolution of the plastic body. For example, the protective layer or the remaining parts of the protective layer can be precipitated from the aqueous PVOH-containing solution, e.g. by filtration.

Preferably, the protective layer comprises parylenes or an inorganic-organic hybrid polymer, which is known under the name ORMOCER and was developed by the Fraunhofer Institute for Silicate Research (DE).

Alternatively, the protective layer can be manufactured from a material with a melting temperature between 50° and 90° Celsius, preferably 60° to 85° Celsius. At temperatures above the melting temperature, the protective layer is destroyed and the plastic body exposed in the process is accessible for the dissolution in water.

The meltable protective layer comprises a material selected from shellac, wax, such as e.g. beeswax, carnauba wax or paraffin wax, or combinations thereof. Shellac that is permitted for food, preferably with a melting temperature between 65 to 85° C., is worth considering as shellac.

Alternatively, the protective layer can be manufactured from an amide wax with a dripping point above 100° C., preferably an amide wax made from sugarcane with a dripping point above 130° C. (e.g. an ethylene-bis-stearamide wax (EBS), which known under the name DEUREX® X 20). An amide wax of this type is particularly suitable e.g. for the production of water-soluble beverage capsules, e.g. Nespresso®-compatible coffee capsules. Such capsules may have a completely coated plastic body.

A further alternative is a protective layer made from a starch-based lacquer.

The protective layer can be built in a multi-layered manner from various materials. Particularly suitable is a meltable protective layer with a first, inner layer made from wax, and a second, outer layer made from shellac. In this case, the inner layer which is made from wax is water- and water-vapour-tight. The outer layer, which is made from shellac, is tight with respect to splash water and flowing water. In addition, it is harder than the wax layer located therebelow and protects the same from undesired damage during the intended use of the plastic article. Furthermore, the layer made from shellac creates a more pleasant surface feel for the user of the plastic product compared to a single outer layer made from wax, the surface feel of which is more greasy or oily. Very good results were achieved with an inner layer made from carnauba wax and an outer layer made from shellac located thereabove. The two layers can be melted in hot water with a temperature of 50° C. to 90° C. and the plastic body, which is located therebelow, becomes accessible for dissolution in water.

The protective layer can be designed to be single- or multi-layered, depending on requirements. Thus, for example, a plastic container for dry substances may only be provided with a protective layer on the outside, i.e. in the regions which are exposed to the ambient moisture. After opening of the plastic container, the inner region is accessible and a plastic container of this type can easily be degraded or dissolved after the intended use. If a moist or wet substance is stored in the plastic container, then a protective layer is also present internally.

In the case of multi-layered protective layers made from e.g. a first inner wax layer and a second outer shellac layer, the shellac layer may also be applied only in the regions which are touched by the user during the intended use. Thus, e.g. a disposable cup may be provided with a wax layer completely and only applied externally in the contact region and partially in the internal edge region, where the user starts to drink.

The plastic product has a shaping plastic body, which is formed from water-soluble polyvinyl alcohol (PVOH), and a thin water-resistant coating, which collapses in on itself or crumbles after the dissolution of the supporting plastic body or the coating melts prior to the dissolution process in hot water. Surfaces of the plastic body, which are only exposed to moisture or water after the intended use, do not have to be coated in this case. A plastic product of this type is stable and durable from production until and during the intended use, i.e. from completion of the plastic product or the article comprising the plastic product, through storage up until the time at which the intended use of the product or the article ends and the same is, if appropriate, partially destroyed.

PVOH is a water-soluble thermoplastic plastic, which —depending on the degree of polymerization and degree of hydrolysis—decomposes or dissolves within minutes to hours upon contact with water. Due to the water solubility, PVOH has hitherto also not been used as a supporting, shaping material for plastic products such as disposable articles or packaging parts, except in applications in which the packaging should be dissolved during use (e.g. water-soluble packaging of dishwasher tabs). In the case of the plastic product according to the invention, however, the plastic body is completely produced from PVOH (injection moulding, deep drawing, blow moulding, etc.) and provided with a water-resistant protective layer. The protective layer in this case ensures the resistance of the plastic products until after the intended use, specifically even in the presence of water. As soon as the plastic product should be disposed of, the protective coating is partially lifted, e.g. by breaking, cutting or shredding the plastic product, or a non-coated surface is exposed at the end of the intended use, so that the plastic body, which is made from water-soluble PVOH, becomes accessible for water and can dissolve. The plastic body is therefore completely soluble in water and can, if appropriate, be disposed of after separation from the coating residues in water, by means of a wastewater treatment plant in which the PVOH, which is dissolved in water, is biodegraded.

On the surfaces which are exposed to ambient moisture or a water-containing substance from completion of the plastic product until and during the intended use of the plastic product, the water-resistant protective layer is complete and continuous, it does not have any faults or holes and covers this surface completely.

A water-resistant protective layer means a layer which is neither hydrolysable nor hydratable from completion of the plastic product until and during the intended use of the plastic product. No breakdown or dissolution takes place by means of water.

In a few embodiments, the PVOH may be moisture-resistant, so that it does not decompose due to air humidity alone. Dissolution only takes place in water or in an aqueous solution.

In a few embodiments, the PVOH may be dissoluble at room temperature within 2 hours, preferably within 60 minutes, further preferably within 30 minutes.

In a few embodiments, the PVOH may only be dissoluble in water from a temperature of at least 40° C., preferably more than 50° C., within 2 hours, preferably within 60 minutes, further preferably within 30 minutes.

Consumer articles or disposable articles in particular, such as for example plastic plates, cups or cutlery, disposable medical articles, such as e.g. syringes, syringe pistons and needle holders, or disposable laboratory articles, such as e.g. reagent vessels and pipette tips, or plastic packaging containers, for example for food, luxury food or drugs, are worth considering as plastic products.

In a few embodiments, the plastic body may be a plastic packaging container, which can be closed using a closure part, e.g. in the form of a sealing film or a plastic cap. A plastic packaging container of this type stands out owing to a particularly good barrier effect with respect to e.g. oxygen, as it consists virtually completely of PVOH. The barrier effect is increased additionally with the protective layer.

In a few embodiments, the inner surface of the closed packaging container cannot be provided with the protective layer. This is the case in particular if the packaging content is completely dry. After the opening and consumption of the content, the plastic body of the plastic product or packaging container can simply be dissolved in water, as the inner surface of the plastic body is not coated.

The plastic packaging container can for example be designed to be cup-shaped with a circumferential sealing flange. In this case, the closure part may be a conventional aluminium foil, which is applied onto the flange. During use, the aluminium foil is removed and disposed of separately. The plastic body of the packaging container can subsequently be dissolved in water.

In order to achieve a good seal, a sealing region of the flange may be free from the protective layer. This is easy to achieve, in that the plastic packaging container is coated with the protective layer with the flange lying on a support. The support region does not receive a protective layer in this manner.

In a few embodiments, at least the outer surface of the plastic packaging container, which is exposed to the outside environment in the closed state of the plastic packaging container, is coated with the protective layer. A plastic packaging container of this type is only suitable for dry filling material, however. In the case of moist or liquid filling material, the plastic packaging container is provided with a protective layer externally and internally.

In a few embodiments, the plastic body may be a closure means for a plastic packaging container. This may be used together with the previously described plastic packaging container. The closure means may be a sealing film, which does not have a protective layer in the sealing region.

In a few embodiments, the closure means may be a plastic cap, which can be placed onto a plastic packaging container in a sealing manner.

In a few embodiments, the plastic product may be a catering product, for example cutlery, a plate or a drinking vessel.

In a few embodiments, the plastic product can be dimensionally stable and self-supporting.

In a few embodiments, the protective layer may be 0.01 to 500 μm (micrometres), preferably 50 to 200 nm (nanometres) thick.

In a few embodiments, the protective layer can be applied by means of vacuum coating methods (e.g. for parylenes or inorganic-organic hybrid polymers) or by means of spray or dipping methods (e.g. for wax or shellac).

The plastic body of the plastic product can be manufactured using commonly used production methods, such as e.g. injection moulding, deep drawing, blow moulding, extrusion, etc.

In a few embodiments or as an alternative solution, the plastic body can be manufactured from cold-water-soluble PVOH, which can dissolve well even in cold water, i.e. at temperatures below 20° C., wherein the surface of the plastic body, which is exposed to ambient moisture or a water-containing substance from completion of the plastic product until and during the intended use of the plastic product, is coated completely with a continuous protective layer likewise made from PVOH, but which is only soluble in warm water, i.e. at temperatures above 40° C., preferably over 50° C. After the intended use of the plastic product, the plastic body is completely soluble in warm water upon dissolution or destruction of the continuous protective layer. In this case, the thinly applied protective layer is also dissolved completely, which further facilitates environmentally sound disposal. The plastic body can preferably be dissolved completely at 20° C. within 2 hours, further preferably within minutes. The protective layer made from warm-water-soluble PVOH is preferably only soluble at temperatures above 40° C., further preferably above 50° C., and in this case protects the easily soluble plastic body, which is located therebelow, from air humidity and direct contact with “cold” aqueous substances. Only at high water temperatures is the protective layer finally destroyed and the plastic product dissolves in water completely in a short time. This embodiment is particularly suitable for disposable products with relatively short life cycles of a few months, which come into contact with cold liquids during the intended use.

Examples are e.g. cups for cold beverages or containers for fresh products, such as e.g. salad. This embodiment can also be considered as a stand-alone invention.

### SHORT DESCRIPTION OF THE FIGURES

The invention shall be explained in more detail in the following on the basis of exemplary embodiments in connection with the drawing(s). In the figures:

FIG. 1 shows a sectional illustration of a plastic product in the form of a plate;

FIG. 2 shows a sectional illustration of a plastic product in the form of a packaging container closed with a sealing film; and

FIG. 3 shows a sectional illustration of a plastic product in the form of a packaging container closed with a plastic cap.

### WAYS OF REALIZING THE INVENTION

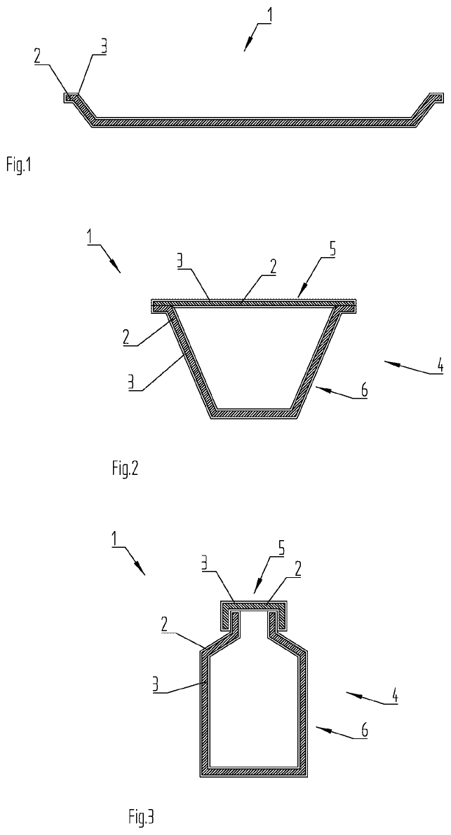

FIG. 1 shows a plastic product 1 in the form of a plate. The plate has a plastic body 2 made from water-soluble polyvinyl alcohol (PVOH). In order to protect the plate from water and thus its decomposition or dissolution until and during the intended use, it is completely provided with a water-vapour-impermeable protective layer 3. The protective layer 3 comprises e.g. parylenes or an inorganic-organic hybrid polymer. In this manner, the plastic body 2 made from PVOH is protected from decomposition or dissolution by water, until the PVOH located below the protective layer is at least partially exposed, e.g. by breaking or cutting of the plastic product 1. Good results were also achieved using a multi-layered protective layer made from a first inner layer made from wax, preferably carnauba wax, and a second outer layer made from shellac. A protective layer of this type may have a melting temperature of more than 65° C., so that the plastic product is also suitable for warm beverages and/or meals.

FIGS. 2 and 3 each show a closed plastic packaging container 4. The plastic packaging container 4 comprises a container body 6 and a closure means 5, which closes the container body 6 in a sealing manner. Analogously to the previously described plastic product from FIG. 1, the container body 6 has a plastic body made from water-soluble PVOH and a protective layer 3.

In the embodiment shown in FIG. 2, the container body 6 is designed to be cup-shaped and has a sealing flange 7, onto which a closure means 4 is adhesively bonded or welded in the form of a sealing film. Depending on the type of sealing, the sealing flange 7 may have a sealing zone which is not provided with the protective layer 3, i.e. is protective-layer-free. The sealing film may be a conventional sealing film made from aluminium, which is disposed of separately after removal. Alternatively, the sealing film may likewise have a plastic body made from PVOH, which is provided with a previously described protective layer 3. If the container 6 is provided for dry substances, then it is possible to dispense with a coating of the interior. In the case of coating with a first inner layer made from wax, preferably carnauba wax, and a second outer layer made from shellac, it is possible to dispense with the shellac layer in the interior of the container.

In the embodiment shown in FIG. 3, the container body 6 is designed to be bottle-shaped. The closure means 5 in the form of a plastic cap can in this case be attached on the neck of the bottle in a sealing manner. In this case, the plastic cap generally has a plastic body 2 made from PVOH, which is provided with a previously described protective layer 3.

### LIST OF REFERENCE NUMBERS

1 Plastic product
2 Plastic body
3 Protective layer
4 Plastic packaging container
5 Closure means
6 Container body

1-16. (canceled)

17. A plastic product having a plastic body injection-moulded or deep-drawn from water-soluble polyvinyl alcohol (PVOH),
wherein a surface of the plastic body which is exposed to ambient moisture or a water-containing substance from completion of the plastic product until and during the intended use of the plastic product, is coated completely with a continuous water-impermeable and water-resistant protective layer,
wherein after the intended use of the plastic product, the plastic body is, upon exposure of a non-coated surface or after destruction of the continuous protective layer, completely soluble in water;
wherein the protective layer is applied with a thickness such that the protective layer disintegrates or is separable from the water after the dissolution of the plastic body, and/or wherein the protective layer has a melting temperature between 50° and 90° Celsius.

18. The plastic product according to claim 17, wherein the protective layer comprises parylenes or an inorganic-organic hybrid polymer.

19. The plastic product according to claim 17, wherein the protective layer comprises a material selected from shellac, wax, or combinations thereof.

20. The plastic product according to claim 17, wherein the protective layer is built in a multi-layered manner from various materials.

21. The plastic product according to claim 20, wherein the protective layer has a first inner layer made from wax and a second outer layer made from shellac.

22. The plastic product according to claim 17, wherein the PVOH is dissoluble at room temperature within 2 hours.

23. The plastic product according to claim 17, wherein the PVOH is only dissoluble in water from a temperature of at least 40° C., within 2 hours.

24. The plastic product according to claim 17, wherein the plastic product is a packaging container.

25. The plastic product according to claim 24, wherein the inner surface of the closed packaging container is not provided with the protective layer.

26. The plastic product according to claim 24, wherein the packaging container is only provided with the protective layer on the outside or externally and internally.

27. The plastic product according to claim 24, wherein the packaging container is closed with a closure means.

28. The plastic product according to claim 27, wherein the closure means is in the form of a sealing film or a plastic cap.

29. The plastic product according to claim 17, wherein the plastic product is a catering product.

30. The plastic product according to claim 17, wherein the plastic product is dimensionally stable and self-supporting.

31. The plastic product claim 17, wherein the protective layer is 0.01 to 500 μm (micrometres) thick.

32. The plastic product according to claim 17, wherein the protective layer is applied by vacuum coating methods, spray or dipping methods.

33. The plastic product according to claim 17, wherein the protective layer has a melting temperature between 60° to 85° Celsius.

34. A plastic product having a plastic body injection-moulded or deep-drawn from cold-water-soluble polyvinyl alcohol (PVOH), wherein a surface of the plastic body, which is exposed to ambient moisture or a water-containing substance from completion of the plastic product until and during the intended use of the plastic product, is coated completely with a continuous protective layer made from warm-water-soluble polyvinyl alcohol (PVOH), and after the intended use of the plastic product, the plastic body is completely soluble in water having a water temperature above 40° C. upon dissolution or after destruction of the continuous protective layer.

35. The plastic product according to claim 34, wherein the water temperature is above 50° C.
